(19) United States
(12) Patent Application Publication
(10) Pub. No.: US 2026/0336387 A1
(43) Pub. Date: Oct. 29, 2026

(54) Utility Vehicle

(71) Applicant: Kubota Corporation, Osaka-shi (JP)

(72) Inventors: Masashi Inoue, Sakai-shi (JP); Miharu Sakaguchi, Sakai-shi (JP); Kohta Nakao, Sakai-shi (JP); Tetsuya Tanigawa, Sakai-shi (JP); Jun Yoshida, Sakai-shi (JP); Shota Watase, Sakai-shi (JP)

(21) Appl. No.: 19/404,655

(22) Filed: Dec. 1, 2025

(30) Foreign Application Priority Data
Apr. 23, 2025 (JP) 2025-071862

(51) Int. Cl. B60K 13/02; B60K 5/00; B60K 13/04; B62D 25/02; B62D 33/02

(52) U.S. Cl. CPC B60K 13/02; B60K 5/00; B60K 13/04; B62D 25/02; B62D 33/02; B60K 2005/003

(57) ABSTRACT

A utility vehicle includes a driver section disposed in a front portion of a body of the utility vehicle; a loading deck disposed behind the driver section; a motor section disposed below the loading deck and including an engine and an exhaust guiding section configured to guide exhaust from the engine to outside; an external air inlet configured to introduce external air from a lateral portion of the body; and an external-air guiding section configured to supply the external air introduced by the external air inlet to the motor section.

### CROSS-REFERENCE TO RELATED APPLICATION

This application claims priority to Japanese Patent Application No. 2025-071862 filed Apr. 23, 2025, the disclosure of which is hereby incorporated by reference in its entirety.

### BACKGROUND OF THE INVENTION

### 1. Field of the Invention

The present invention relates to a utility vehicle.

### 2. Description of Related Art

As disclosed in Japanese Unexamined Patent Application Publication No. 2014-184832, for example, a utility vehicle includes a driver section disposed in a front portion of a body of the utility vehicle, a loading deck disposed behind the driver section, and a motor section disposed below the loading deck. In such a utility vehicle, the front side of the motor section is covered with the driver section, and its upper side is covered with the loading deck. The motor section includes an engine, and an exhaust guiding section configured to guide exhaust from the engine to the outside.

In the utility vehicle described above, the temperature of air in the motor section may become high due to heat generated by the engine, the exhaust guiding section, and the like. Due to the presence of the driver section and the loading deck, the high-temperature air might stay in the motor section. Particularly, in a case where the driver section has a highly-airtight configuration, the air highly tends to stay in the motor section into which external air rarely flows.

In view of this, it is conceivable to provide a draft air duct for introducing external air from the front or top of the vehicle in order to introduce the external air as the vehicle travels. However, in this case, spaces for the driver section and the loading deck are limited, which causes such a disadvantage that a compartment space becomes small or workability decreases due to an increase in the height of the loading deck.

### SUMMARY OF THE INVENTION

An object of the present invention is to avoid high-temperature air from staying in a motor section without limiting spaces for a driver section and a loading deck.

A feature configuration of a utility vehicle according to the present invention is as follows. That is, the utility vehicle includes: a driver section disposed in a front portion of a body of the utility vehicle; a loading deck disposed behind the driver section; a motor section disposed below the loading deck and including an engine and an exhaust guiding section configured to guide exhaust from the engine to outside; an external air inlet configured to introduce external air from a lateral portion of the body; and an external-air guiding section configured to supply the external air introduced by the external air inlet to the motor section.

In the present invention, external air is introduced by the external air inlet as the utility vehicle travels, and the external air thus introduced is supplied to the motor section by the external-air guiding section. As a result, it is possible to avoid high-temperature air from staying in the motor section without limiting spaces for the driver section and the loading deck due to a draft air duct for introducing the external air from the front or top of the vehicle.

In the present invention, the utility vehicle may further include a cover disposed on the lateral portion of the body to be connected to a rear portion of the driver section and configured to cover a lateral side of the motor section, the cover having an opening facing forward in a front-rear direction of the body, and an inclined guide surface connected to a rear side of the opening and inclined inward in the body toward a rear side in the front-rear direction, such that the opening and the inclined guide surface define the external air inlet.

In this configuration, the lateral side of the motor section is covered with the cover, thereby making it possible to avoid foreign substances from entering the body from outside the lateral portion of the body. By making good use of the cover, the configuration of the external air inlet can be made simple.

In the present invention, the external-air guiding section may be formed of a wall member having a transverse guide surface configured to receive the external air introduced by the external air inlet and guide the external air inward in the body.

With this configuration, it is possible to efficiently supply the motor section with the external air introduced by the transverse guide surface of the wall member.

In the present invention, the utility vehicle may further include a cover disposed on the lateral portion of the body to be connected to a rear portion of the driver section and configured to cover a lateral side of the motor section, and the external-air guiding section may be formed of a wall member integral with the cover.

In this configuration, by providing the cover for covering the lateral side of the motor section, it is possible to easily avoid leaf debris and other dust from entering the motor section from outside the lateral portion of the body while the body travels. Besides, the inside of the motor section can hardly be observable from outside the body, thereby making it possible to improve the appearance of the utility vehicle. By forming the external-air guiding section using such a cover, it is possible to easily avoid high-temperature air from staying in the motor section while a large cost increase is suppressed by using a component for multiple purposes.

In the present invention, the driver section may be covered with a cabin.

With this configuration, external air flows along the lateral wall portion of the cabin at the lateral portion of the body, so that the external air can be easily introduced by the external air inlet.

### BRIEF DESCRIPTION OF THE DRAWINGS

FIG. 1 is an overall side view;

FIG. 2 is a side view illustrating a motor section and an external air inlet; and

FIG. 3 is a plan view illustrating the motor section and the external air inlet.

### DESCRIPTION OF THE INVENTION

The following describes an embodiment of a utility vehicle according to the present invention with reference to the drawings. Note that the present invention is not limited to the following embodiment and can be variously modified without departing from the gist of the present invention.

In the following description, the direction of arrow F in the drawings indicates a "forward direction," the direction of arrow B indicates a "rearward direction," the direction of arrow "L" indicates a "leftward direction," and the direction of arrow R indicates a "rightward direction," unless otherwise specified. Besides, in the drawings, the direction of arrow U indicates an "upward direction," and the direction of arrow D indicates a "downward direction."

### Overall Configuration of Utility Vehicle

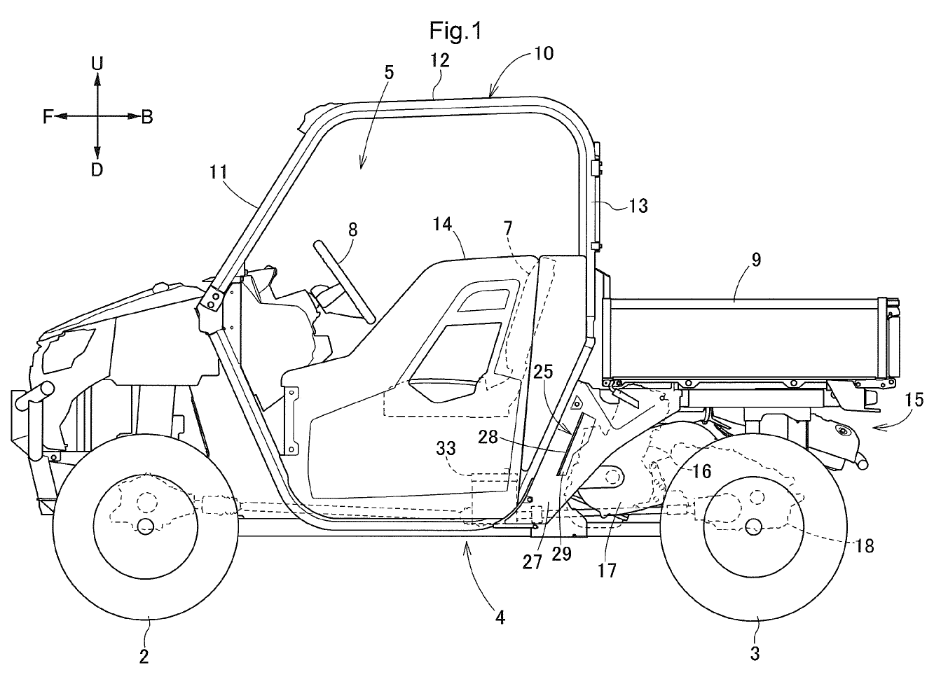

A utility vehicle illustrated in FIG. 1 is used for multipurpose applications such as transportation of articles and recreational activities. The utility vehicle includes a travel body 4 including a pair of right and left front wheels 2 steerably and drivably held by a front portion of the body, and a pair of right and left rear wheels 3 drivably held by a rear portion of the body. A driver section 5 is provided in the travel body 4 to be located between the front wheels 2 and the rear wheels 3. The driver section 5 includes a driver seat 7, a steering wheel 8 for steering the front wheels 2, and the like. A loading deck 9 on which various articles can be loaded is disposed behind the driver section 5. Accordingly, the driver section 5 is located at the front portion of the body, and the loading deck 9 is located behind the driver section 5.

The driver section 5 is covered with a cabin 10. Although not described in

detail, the cabin 10 includes a windshield 11, a ceiling 12 covering the upper side of the driver seat 7, a back surface portion 13 connected to the ceiling 12, right and left doors 14 disposed on lateral portions of the cabin 10 to be openable and closeable, and the like.

### Motor Section

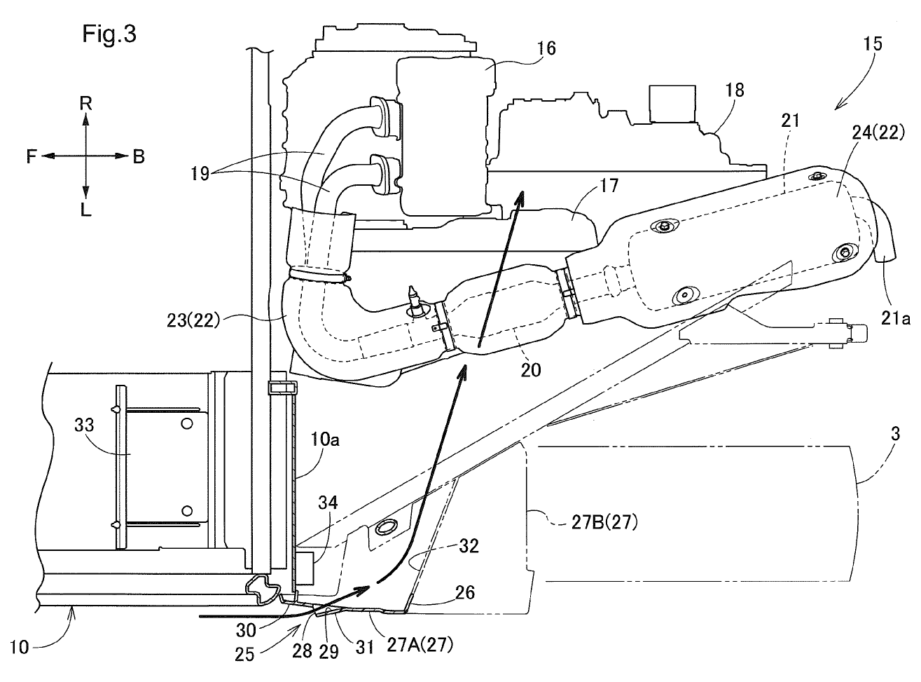

A motor section 15 is disposed below the loading deck 9. As illustrated in FIG. 3, the motor section 15 includes an engine 16, a continuously variable transmission 17 configured to receive an output from the engine 16 and continuously vary input power, and a transmission 18 configured to receive an output from the continuously variable transmission 17, vary input power by gears, and output the power to the front wheels 2 and the rear wheels 3. The continuously variable transmission 17 is coupled to a lateral portion of the engine 16 and a lateral portion of the transmission 18. In the continuously variable transmission 17, the input power is varied by means of an endless rotation belt (not illustrated) and a belt pulley (not illustrated) changeable in winding diameter. The transmission 18 is disposed behind the engine 16.

The motor section 15 includes an exhaust guiding section H configured to guide exhaust from the engine 16 to the outside. Next will be described the exhaust guiding section H.

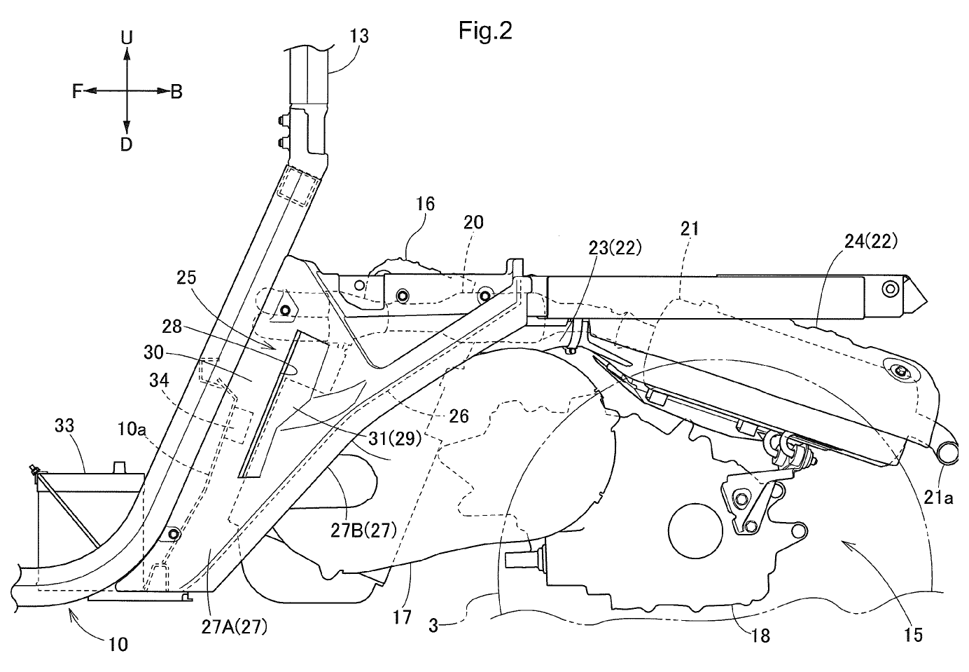

As illustrated in FIGS. 2-3, an exhaust pipe 19 is extended from the engine 16, a first muffler 20 is connected to the exhaust pipe 19, and a second muffler 21 is connected to an end portion of the first muffler 20. A rear portion of the second muffler 21 is held by the transmission 18. Exhaust from the engine 16 is discharged to the first muffler 20 via the exhaust pipe 19, so that exhaust gas is purified by a catalyst in the first muffler 20. The exhaust gas discharged from the first muffler 20 is introduced into the second muffler 21, and the exhaust gas is silenced in the second muffler 21 and discharged from a discharge cylinder 21a of the second muffler 21.

The exhaust pipe 19 is covered with an exhaust pipe cover 22. Transfer of heat generated by the exhaust pipe 19 to the loading deck 9 and the like is suppressed by the exhaust pipe cover 22. The first muffler 20 is covered with a first muffler cover 23, and the second muffler 21 is covered with a second muffler cover 24. With this configuration, transfer of heat generated by the first muffler 20 and the second muffler 21 to the loading deck 9 and the like is suppressed.

The utility vehicle includes an external air inlet 25 configured to introduce external air from a lateral portion of the body, and an external-air guiding section 26 configured to supply the external air introduced by the external air inlet 25 to the motor section 15.

A lateral cover 27 (an example of a cover) configured to cover the left side of the motor section 15 is disposed on a left lateral portion of the body to be connected to a rear portion of the driver section 5. The lateral cover 27 has an opening 28 facing forward in the front-rear direction of the body, and an inclined guide surface 29 connected to the rear side of the opening 28 and inclined inward in the body toward the rear side of the body. The opening 28 and the inclined guide surface 29 form the external air inlet 25.

The lateral cover 27 is provided to cover the front side of a lateral portion of the motor section 15 in the front-rear direction of the body. In a side view of the body, the lateral cover 27 has a rear edge inclined upward toward the rear side generally along an outer peripheral portion of the left rear wheel 3. The lateral cover 27 is manufactured by integral molding of a synthetic resin material and includes a lateral wall portion 27A extending in the front-rear direction, and a rear wall portion 27B extending inward in the body in the right-left direction from a rear end portion of the lateral wall portion 27A. The lateral wall portion 27A and the rear wall portion 27B are formed integrally.

As illustrated in FIG. 1, the lateral cover 27 is provided such that a front edge of the lateral wall portion 27A is connected to a rear end portion of the left door 14 in the driver section 5, and the lateral wall portion 27A extends rearward in the body. As illustrated in FIGS. 2, 3, the lateral cover 27 includes, in the middle of the lateral wall portion 27A in the front-rear direction, a front wall portion 30, and an inclined wall portion 31 having a front portion located outward of the body and inclined inward in the body toward the rear side. The opening 28 facing forward in the front-rear direction of the body is defined by a rear edge of the front wall portion 30, and a front edge of the inclined wall portion 31 located outward of the rear edge of the front wall portion 30.

Accordingly, external air is introduced through the opening 28 as the body travels. The external air introduced through the opening 28 is guided to flow inward toward the rear side along an inner surface of the inclined wall portion 31. The inner surface of the inclined wall portion 31 corresponds to the inclined guide surface 29.

The external air introduced by the external air inlet 25 and guided to flow inward toward the rear side is received by the front surface of the rear wall portion 27B of the lateral cover 27 and is further guided to flow inward in the body. Accordingly, the front surface of the rear wall portion 27B forms a transverse guide surface 32 configured to receive the external air introduced by the external air inlet 25 and guide the external air inward in the body, and the rear wall portion 27B formed integrally with the lateral cover 27 corresponds to a wall member forming the external-air guiding section 26.

As described above, in a side view of the body, the rear edge of the lateral wall portion 27A of the lateral cover 27 is inclined upward toward the rear side. The rear wall portion 27B is provided along the rear edge of the lateral wall portion 27A to extend inward in the body in the right-left direction. That is, the rear wall portion 27B is inclined upward toward the rear side in a side view of the body.

As illustrated in FIG. 1, a battery 33 is disposed below the driver seat 7. As illustrated in FIGS. 2, 3, a power extraction section 34 (bus bar) configured to send electric power from the battery 33 to an optional device (not illustrated) that is externally attachable to the body of the vehicle, such as a work light, for example, is disposed on the left side of a rear wall 10a of the cabin 10.

As illustrated in FIG. 3, the lateral cover 27 is located forward of the left rear wheel 3. The rear wall portion 27B of the lateral cover 27 is located forward of the rear wheel 3 and extends in the up-down direction to be inclined along the outer peripheral portion of the rear wheel 3. The rear wall portion 27B of the lateral cover 27 has a function to cover the power extraction section 34 to prevent mud or the like splashed by the rear wheel 3 from being scattered over the power extraction section 34.

The external air introduced through the opening 28 is received by the front surface (the transverse guide surface 32) of the rear wall portion 27B, guided rearward and upward by the front surface, and guided inward in the body as illustrated in FIGS. 2, 3. As a result, the air in the motor section 15 which air is increased in temperature due to heat generated by the exhaust pipe 19, the first muffler 20, the second muffler 21, and the like in the motor section 15 is blown rearward by the external air thus guided to flow. This accordingly makes it possible to easily avoid the high-temperature air to stay in the motor section 15.

### Alternative Embodiments

(1) The above embodiment has described the configuration in which the lateral cover 27 on the lateral portion of the body has the opening 28 facing forward in the front-rear direction of the body, and the inclined guide surface 29 connected to the rear side of the opening 28 and inclined inward in the body toward the rear side of the body, such that the opening 28 and the inclined guide surface 29 define the external air inlet 25. However, instead of this configuration, the utility vehicle may include a pipe material projecting outward from the lateral cover 27 and having an opening at one end of the pipe material to face forward in the front-rear direction of the body so that the external air is introduced by the pipe material, for example. Alternatively, the utility vehicle may include a wind deflector, a ventilating duct, or the like for exclusive use of introduction of external air without providing the lateral cover 27, and various configurations can be employed as the external air inlet 25.
(2) The above embodiment has described the configuration in which the external-air guiding section 26 is formed of the rear wall portion 27B formed integrally with the lateral cover 27. However, instead of this configuration, the utility vehicle may include an air guide plate or a duct for exclusive use of air guide, formed separately from the lateral cover 27.
(3) The above embodiment has described the configuration in which the driver section 5 is covered with the cabin 10 having a lateral portion partially opened. The cabin may be a cabin having a highly-airtight configuration with an air conditioner, for example, and the configuration of the driver section 5 can be achieved by adding various changes.

Note that the configurations of the embodiments described above (including alternative embodiments, which also applies hereinafter) may be combined with a configuration disclosed in another embodiment, provided that such a combination does not result in a contradiction. The embodiments described in the present specification are illustrative and should not be construed as limiting the present invention. Modifications to the present invention are permissible, as long as they do not deviate from the scope that can achieve the objects of the present invention.

### INDUSTRIAL APPLICABILITY

The present invention is applicable to a utility vehicle used for transfer of people, transportation of articles, recreational activities, and the like.

### DESCRIPTION OF THE REFERENCE NUMERALS

5: driver section
9: loading deck
10: cabin
15: motor section
16: engine
25: external air inlet
26: external-air guiding section
27: cover
27B: wall member
28: opening
29: inclined guiding section
32: transverse guide surface
H: exhaust guiding section

What is claimed is:

1. A utility vehicle, comprising:
a driver section disposed in a front portion of a body of the utility vehicle;
a loading deck disposed behind the driver section;
a motor section disposed below the loading deck and comprising an engine and an exhaust guiding section configured to guide exhaust from the engine to outside;
an external air inlet configured to introduce external air from a lateral portion of the body; and
an external-air guiding section configured to supply the external air introduced by the external air inlet to the motor section.

2. The utility vehicle according to claim 1, further comprising:
a cover disposed on the lateral portion of the body to be connected to a rear portion of the driver section and configured to cover a lateral side of the motor section, the cover having an opening facing forward in a front-rear direction of the body, and an inclined guide surface connected to a rear side of the opening and inclined inward in the body toward a rear side in the front-rear direction, such that the opening and the inclined guide surface define the external air inlet.

3. The utility vehicle according to claim 1, wherein:
the external-air guiding section is formed of a wall member having a transverse guide surface configured to receive the external air introduced by the external air inlet and guide the external air inward in the body.

4. The utility vehicle according to claim 3, further comprising:
a cover disposed on the lateral portion of the body to be connected to a rear portion of the driver section and configured to cover a lateral side of the motor section, and
wherein the external-air guiding section is formed of a wall member integral with the cover.

5. The utility vehicle according to claim 4, wherein:
the cover comprises:
a lateral wall portion extending in the front-rear direction; and
a rear wall portion extending inward in the body along a right-left direction of the body from a rear end portion of the lateral wall portion, and
wherein the external-air guiding section is formed of the rear wall portion.

6. The utility vehicle according to claim 1, wherein:
the driver section is covered with a cabin.
